(19) United States
(12) Patent Application Publication
(10) Pub. No.: US 2002/0186402 A1
(43) Pub. Date: Dec. 12, 2002

(54) Producing and distributing a photo product at a selected location for delivery to a designee

(75) Inventors: William M. Jackson, Victor, NY (US); Kenneth A. Parulski, Rochester, NY (US)

Correspondence Address: Thomas H. Close, Eastman Kodak Company, Patent Legal Staff, 343 State Street, Rochester, NY, 14650-2201, US

(73) Assignee: Eastman Kodak Company

(21) Appl. No.: 09/832,758

(22) Filed: Apr. 11, 2001

(51) Int. Cl. B41J 1/00; H04N 1/00

(52) U.S. Cl. 358/1.15; 358/402

(57) ABSTRACT

A method for ordering a photo product to be printed at a selected location and delivered to a designee, including a user communicating with a service provider that offers a plurality of photo products and selecting a particular photo product to incorporate a digital image provided by the user; the user providing identification of the designee's location where the selected photo product is to be delivered; the service provider automatically selecting, from a plurality of printing locations, a particular printing location based on the identification of the designee's location; using a communications network to transfer the digital image from the user to the particular printing location; and printing the selected photo product at the particular printing location and delivering the photo product to the designee.

### CROSS REFERENCE TO RELATED APPLICATIONS

Reference is made to commonly assigned U.S. patent application Ser. No. 09/691,364 filed Oct. 18, 2000, entitled “Effective Transfer of Images From a User to a Service Provider, by Thomas N. Berarducci et al.; and U.S. patent application Ser. No. 09/416,697 filed Oct. 12, 1999 entitled “Printing and Delivery of Digital Images and Text Via a Central Receiving Agency” to Gustavo Paz-Pujalt et al., the disclosures of which are incorporated herein by reference.

### FIELD OF THE INVENTION

The present invention relates to a method of producing and distributing a photo product to a designee.

### BACKGROUND OF THE INVENTION

The transfer of digital images from a user to a service provider, for producing photo products such as hardcopy prints which are then delivered to the user or a user's designee, is becoming more popular and more important. Typically, a digital camera user takes a plurality of digital images that are stored on a removable memory card. These images can be transferred from the memory card and stored, for example, on a hard drive or other non-volatile memory associated with the user's computer. While these images can be printed on a local printer, such as an ink jet printer, it is often simpler and less expensive for the user to have the images printed by a photo service provider. There are numerous photo services that can be provided using digital images, such as storing, printing, or producing digital storage media (e.g. CD-R discs) with duplicate copies of the digital images. These services can be provided at a remote location by the service provider. When services are ordered from the photo service provider, the images need to be uploaded using a channel such as the Internet.

Digital images, from digital cameras or scanned photographic film, can be uploaded to a web site for viewing, as described in commonly assigned U.S. Pat. No. 5,666,215 to Fredlund et al. Using a web browser, a group of these digital images can be viewed and selected for printing, for example using the Kodak Photonet Service. The user can select the size of each print to be produced, and the quantity of prints to be made from each image.

Album pages can be produced from digital images by arranging numerous images on the same page, as described in commonly assigned U.S. Pat. No. 6,004,061 to Manico et al. These album pages can be customized in terms of the size and arrangement of images on the page, the size and finish of the album pages, and the background color or patterns used.

Some web sites, such as the site provided by OFOTO, Inc. at www.ofoto.com, enable a user to upload a group of digital images for sharing with others over the Internet and for providing digital printing services. This site permits a user to obtain an account using his e-mail address as the account name, and to provide a password and mailing address information. The user can then upload a group of images. After all the images are uploaded, the user can select particular images for printing. The user can select to have the prints delivered to the user's address (or to the address of designee, such as a friend or family member living in another city) via the U.S. Postal service, and is charged a fee for this delivery service. Alternatively, the user can have the prints delivered by express (e.g. one-day) delivery service for an additional fee. In either case, the prints are produced in the same location (e.g. California), independent of the delivery address. For a specific example, if a user wants prints delivered to an East Coast location, the user either has to pay a substantial premium for express delivery, or else has to wait for many days for the prints to arrive.

### SUMMARY OF THE INVENTION

It is an object of the present invention to provide an effective method for producing and distributing a photo product at a selected location for delivery to a designee.

This object is achieved by a method for ordering a photo product to be printed at a selected location and delivered to a designee, comprising the steps of:

(a) a user communicating with a service provider that offers a plurality of photo products and selecting a particular photo product to incorporate a digital image provided by the user;

(b) the user providing an identification of the designee's location where the selected photo product is to be delivered;

(c) the service provider automatically selecting, from a plurality of printing locations, a particular printing location based on the identification of the designee's location;

(d) using a communications network to transfer the digital image from the user to the particular printing location; and

(e) printing the selected photo product at the particular printing location and delivering the photo product to the designee.

### ADVANTAGES

It is an advantage of the present invention to provide a method for producing photo products at a particular printing location, which is near the location to which the photo product will be delivered, in order to minimize the shipping costs.

It is a further advantage of the present invention to provide a method for producing photo products at a particular printing location which is near the location of the designee who will receive the photo product, in order to minimize the time required to deliver the photo product from the particular printing location to the designee.

It is a further advantage of the present invention to provide a method for producing photo products at a particular printing location which is near or at the location of the nearest regional postal center relative to the location of the designee who will receive the photo product, in order to minimize the time and shipping costs required to deliver the photo product from the particular printing location to the designee.

It is a further advantage of the present invention to provide a method for obtaining digital printing services using an Internet accessible server, which allows the user to select the time at which images are transferred to the particular printing location so that it does not interfere with a user's operation of his or her computer or telephone line.

It is a further advantage of the present invention to provide a low cost method of quickly delivering custom printed products to a designee using an existing postal service, which already makes daily deliveries to the designee.

### BRIEF DESCRIPTION OF THE DRAWINGS

FIG. 1 depicts a block diagram of a system that implements this invention;

FIG. 2 is a flow diagram of a typical method for producing and distributing a photo product at a selected location for delivery to a designee;

FIG. 3 depicts a selection of print sizes, picture matte styles, and picture frames provided by the system of FIG. 1;

FIG. 4 depicts a plurality of album page options including album size, background on a page, and album type that can be provided by the system of FIG. 1;

FIG. 5 is a diagram depicting service account information, including identification of a plurality of designee's locations;

FIG. 6 depicts in more detail a digital camera shown as a block in FIG. 1;

FIG. 7 is a graphical user interface screen to enable a user to select images to be uploaded and an effective transfer time; and

FIG. 8 is a diagram depicting examples of representative regional printing centers appropriate for the U.S.A.

### DETAILED DESCRIPTION OF THE INVENTION

The present invention provides an effective method of ordering photo products from a photo service provider at a central location and transferring images over a channel, such as the Internet, to a particular printing location associated with the photo service provider. In a preferred embodiment, the user accesses an Internet web site of the photo service provider, and specifies a designee, such as a friend, relative, or the user himself or herself, to whom the photo product should be delivered. The user provides delivery information for the designee, which is normally the designee's name and mailing address, including the ZIP code in the U.S., or the appropriate postal code in other countries.

In order to provide rapid delivery, the photo service provider is affiliated with many different printing locations, distributed throughout the region served by the photo service provider. These printing locations may be owned and controlled by the photo service provider, or may be operated by separate companies or even by the postal service. These printing locations are preferably associated with regional mailing centers operated by the postal service in that country. The regional mailing centers may cover a large region (e.g. several states in the U.S.) or a much smaller region (e.g. a portion of a large city corresponding to a single ZIP code) depending on the printing volume of the service provider in that region. The photo service provider determines, from the plurality of printing locations, the printing location best suited for minimizing the delivery cost and time, based on the identification of the designee's location (e.g. based on the designee's ZIP code in the U.S.).

The user selects one or more photo products from a menu of options provided by the photo service provider. The menu may include standard prints, enlargements with digitally printed Matt borders, album pages with background images, and other photo products to be described later. In a preferred embodiment, the user uploads low resolution (e.g. thumbnail resolution) digital images to the photo service provider at a central location, and the photo service provider uses these low resolution images to produce representations of the photo products ordered by the user. The user then approves the order and selects a preferred upload time option. The upload time option may represent a preferred upload initiation time, or a time window during which the transfer is desired. Image identifiers are provided for each image to be uploaded and are stored as service account information.

At the appropriate time, the full resolution images are transferred to the particular printing location. In a first embodiment, this transfer is accomplished by the photo service provider communicating the network address to the user, and the user transferring the full resolution digital image files directly to the particular printing location. Additional digital image files needed to produce the photo product, such as the background image data for a photo album, can be communicated from the photo service provider at the central location to the particular printing location. The photo products are then produced at the particular printing location, and are delivered to the designee.

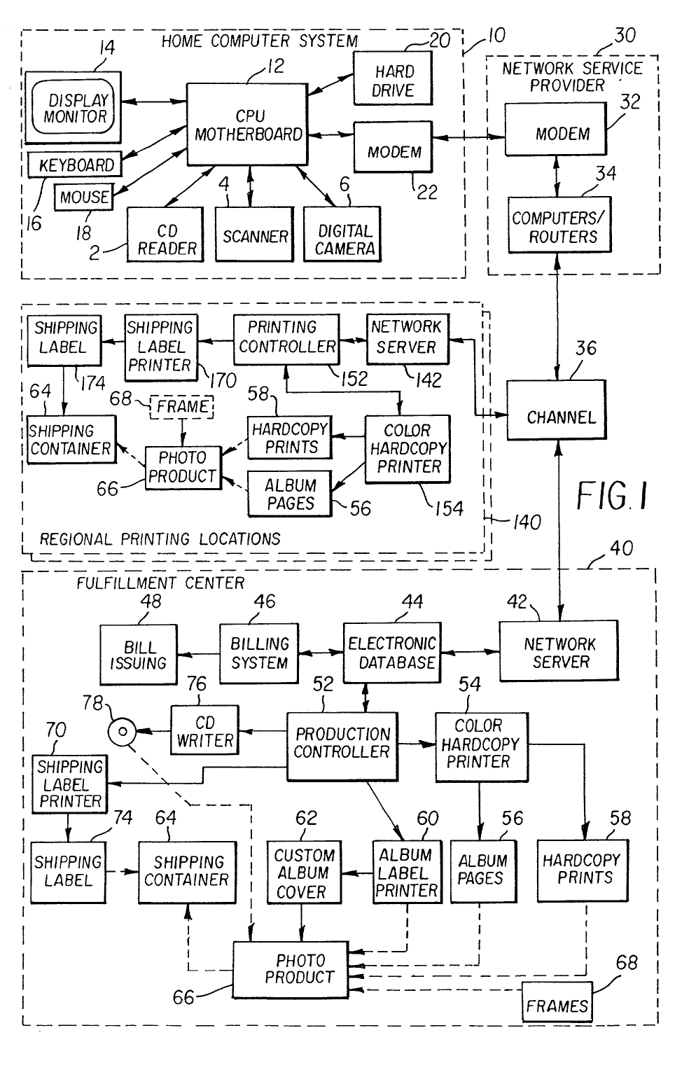

As shown in FIG. 1, the system includes a home computer system (with associated peripherals) 10 located at the customer location (e.g., the user's home). A network services provider 30, such as an Internet service provider (ISP), communicates with the home computer system 10 to provide a network connection for the customer to a channel 36, such as the Internet. It is understood that a system such as a game console, dedicated Internet appliance, or set top box may be substituted for the home computer system. The system further includes a central fulfillment center 40 that communicates with the home computer system 10 and the ISP 30. The central fulfillment center 40 includes an electronic database 44, which is located remote from the user's computer 10. The system further includes a large number of regional printing locations 140. Each regional printing location 140 includes at least one color hardcopy printer 154 capable of producing hardcopy prints 58 from digital images transferred from the home computer system 10 via the channel 36.

The regional printing centers are disbursed across the region served by the service provider, and are preferably located in or near the regional or local mailing centers for the country or countries served by the service provider. In this way, shipping costs can be minimized. The central fulfillment center 40 communicates with each of the regional printing locations 140 in order to specify which particular printing location will be used to produce photo products for each particular customer who has ordered photo products from the central fulfillment center 40. The various portions of the central fulfillment center 40 can be located in a single building or complex of adjacent buildings. Alternatively, the central fulfillment center 40 can be geographically dispersed over several sites in different cities or even different continents. Furthermore, the electronic database 44 can itself be distributed over several computers in several different locations and interconnected via a suitable digital communications network, such as the Internet. In a preferred embodiment, the central fulfillment center 40 also serves as one of the regional printing locations. In a preferred embodiment, the central fulfillment center 40 also includes equipment for producing certain photo products, such as a CD writer 76 for producing a Photo CD 78, which are only ordered by a small number of customers, and which can have a longer delivery time.

The home computer system 10, which can be, for example, a Dell Dimension XPS M200, includes a CPU motherboard 12, using, for example, a Pentium 200 MHz MMX processor as well as RAM memory. The CPU motherboard 12 executes software stored on a hard drive 20, for example, the well-known Windows 98 operating system software and the Internet Explorer web browser software, both provided by Microsoft Corp. of Redmond, Wash. The CPU motherboard 12 is coupled to a display monitor 14 and a keyboard 16. A mouse 18 permits the customer to readily communicate with the CPU motherboard 12. The home computer system 10 also includes a dial-in modem 22 for communicating with the ISP 30 in order to connect to a channel 36, such as the Internet.

The CPU motherboard 12 communicates with a color scanner 4, such as a Microtek ScanMaker E6, which can scan color photographs (not shown) and store digital images of the photographs on the hard drive 20. The CPU motherboard 12 also communicates with a CD reader 2. The CD reader 2 can be used to input digital images from a CD-R disc, such as a Kodak PictureCD (not shown). The CPU motherboard 12 also communicates with a digital camera 6 via a suitable interface, such as the well-known USB or RS-232 serial interfaces. The digital camera 6, for example a Kodak DC280 Zoom digital camera, can be used to provide digital images. The digital images provided by the CD reader 2, scanner 4, and digital camera 6 can be uploaded from the home computer system 10 to the fulfillment center 40 via ISP 30 and channel 36.

An example of an ISP 30 is provided by, for example, Earthlink Network, Inc. of Pasadena, Calif. The ISP 30 includes banks of modems 32, one of which is connected to communicate with the modem 22 of the customer's computer 10. The modem 32 in turn communicates with computers/routers 34 in order to provide a connection to the channel 36 using equipment and techniques well known to those skilled in the art.

The central fulfillment center 40 is connected to the channel 36, such as the Internet, by a network server 42, such as an Internet server, which is comprised of one or more computers and associated peripherals. The electronic database 44 provides information describing numerous photo product options, including printing a group of digital images onto album pages. The electronic database 44 can be contained on the same computer as the network server 42, or can utilize a separate computer, or can be distributed over several computers at the same physical site, or at different sites.

The electronic database 44 includes information describing different features of the albums and other photo products 66 that can be selected and customized by the customer at the remote location, using the customer's home computer system 10. The electronic database 44 includes information describing photo product options, for example album features such as providing various background colors or textures, page numbers, page captions, image captions, etc. The album pages can be bound in a cover, or can include holes to permit the pages to be inserted into a standard binder, such as a three-ring binder. These album feature options can be demonstrated via software programs using, for example, JAVA applets, MPEG movies, QuickTime movies, or Shockwave files, which depict customer selectable features.

When a photo product 66 is purchased by the user, the electronic database 44 communicates with a billing system 46 to verify that the payment identifier (e.g., credit card or debit card number) provided by the customer is valid, and to debit the account for the purchase. As shown in block 48, the bill is issued. The customer's account that is debited can, of course, be located at a remote financial institution. Typically, as with credit cards, this financial institution will make payment to the direct provider or seller of shippable photo product 66. This is generally done by wiring the amount into the direct provider's account, generally an account established with another financial institution.

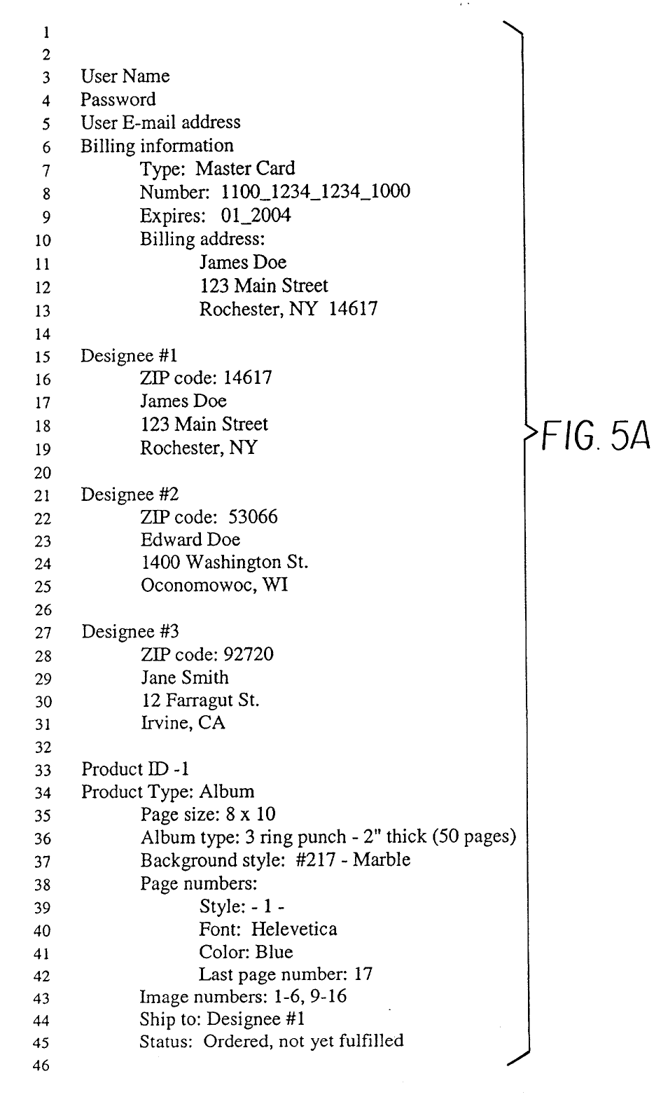

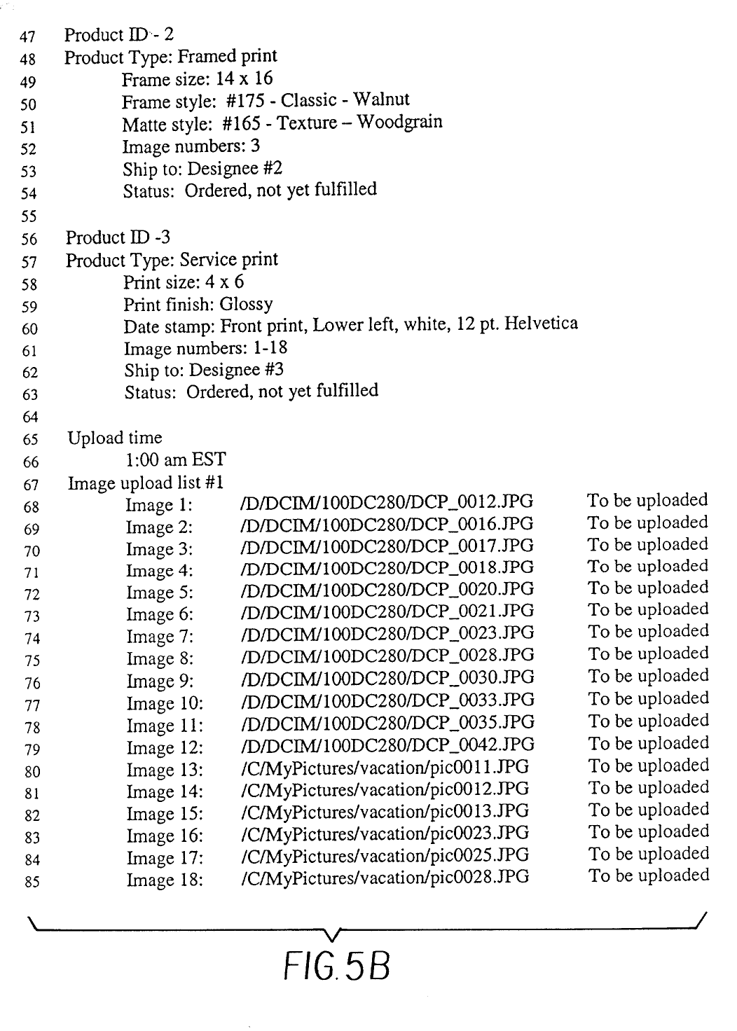

The electronic database 44 includes data that defines the location of each of the regional printing locations 140, the type and capacity of photo products that can be produced at each regional printing locations 140, and the status of each of the regional printing locations 140 (e.g. whether any location is currently inoperative as a result of equipment failure). The production controller 52 in the fulfillment center 40 uses this information, along with the customers service account information, to be described later in reference to FIG. 5, in order to determine which of the regional printing locations should be used to produce some or all of the photo products 66 ordered by the customer.

As shown in FIG. 1, the regional printing locations 140 also communicate with the central fulfillment center 40 via a channel 36. While a separate network could be used, in a preferred embodiment this communication also uses the Internet. Each of the regional printing locations 140 includes a network server 142 for receiving order information and digital images to be printed. In a preferred embodiment, the order information is provided by the central fulfillment center 40 and the digital images are provided directly from the home computer system 10. Each regional printing location 140 includes a printing controller 152 which controls one or more color hardcopy printers 154, which can produce album pages 56 or separate hardcopy prints 58. The printing controller 152 also controls a shipping label printer 170 to produce a shipping label 174. The shipping label 174 is attached to a shipping container 64 (e.g., a cardboard box containing packing material) that contains and protects the photo product 66 during shipment to the customer or the customer's designee. The shipping label 174 can include a postage stamp or mark specifying the correct postage for the delivering the shipping container 64 to the customer's designee. In a preferred embodiment, the postage stamp includes a picture created using a digital image provided by the user. This can be accomplished, for example as described in commonly assigned U.S. patent application Ser. No. 09/378,159 filed Aug. 19, 1999 entitled “System for Customizing and Ordering Personalized Postage Stamps” to David. L. Patton, et al, and U.S. patent application Ser. No. 09/534,433 filed Mar. 23, 2000 entitled “A Method for Printing and Verifying Limited Edition Stamps” to David. L. Patton, the disclosures of which are herein incorporated by reference.

As shown in FIG. 1, the central fulfillment center 40 can also serve as one of the regional printing locations 140. In addition, it can provide certain types of low volume photo products, which are not produced at the other regional printing locations 140. To produce these photo products, the production controller 52 controls one or more color hardcopy printers 54, which can produce album pages 56 or separate hardcopy prints 58. The hardcopy prints can be placed in frames 68. The production controller 52 is also connected to a CD writer 76, which can produce PictureCDs 78 having digital images and application software for using the digital images. The production controller 52 can optionally be connected to devices (not shown) for producing T-shirts, coffee mugs, etc. incorporating one or more images uploaded by the user. The production controller 52 is also connected to an album label printer 60 that produces labels that can be attached to a standard album cover to provide a custom album cover 62.

The production controller 52 also controls a shipping label printer 70 to produce a shipping label 74. The shipping label 74 is attached to a shipping container 64 (e.g., a cardboard box containing packing material) that contains and protects the photo product 66 during shipment to the customer or the customer's designee.

The electronic database 44 also provides long-term storage of the uploaded images, when requested by the user. In this embodiment, stored images are accessible (e.g. viewable) via the Internet by authorized users, as described, for example, in commonly assigned U.S. Pat. No. 5,760,917 to Sheridan, the disclosure of which are herein incorporated by reference.

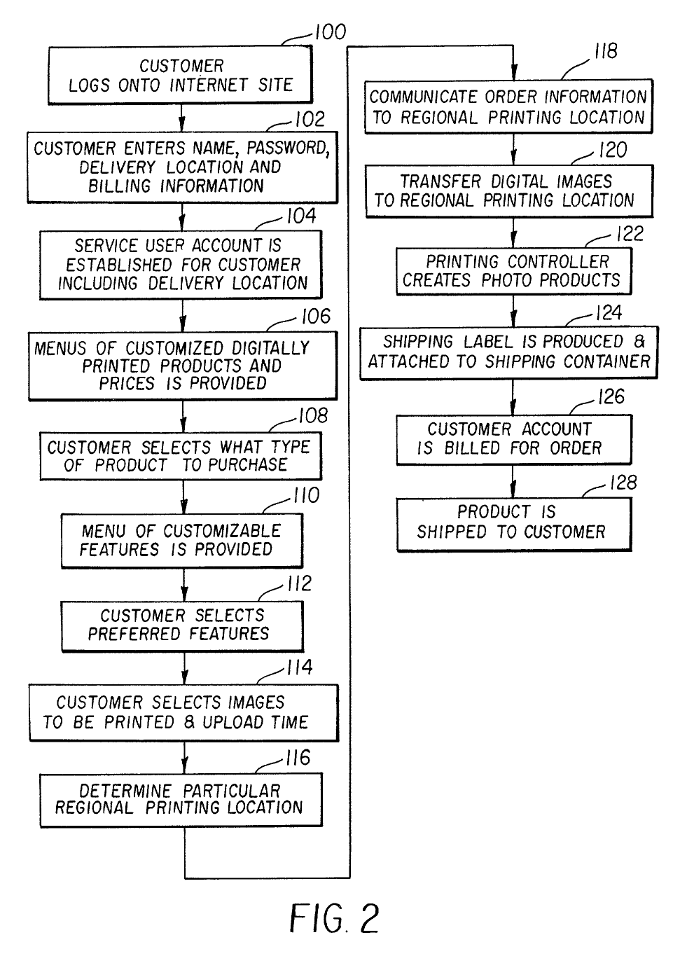

Turning now to FIG. 2, there is shown a flow diagram of a typical method of ordering photo products from a service provider and transferring images over a channel, such as the Internet, to a particular printing location associated with the service provider. As shown in block 100, the customer, using a digital communication network, logs onto the channel 36, which can be the Internet. The customer can, of course, use a network service provider, such as the ISP 30, to gain access to the channel 36. The ISP 30 uses an address, such as an Internet protocol (IP) address, to establish a connection between the customer's computer 10 and a product provider or seller who owns or controls the central fulfillment center 40.

In block 102, the customer enters their name, selects a password, and provides delivery and billing information. This information identifies the customer and one or more customer designees (e.g. the person to whom the photo product 66 should be shipped, which can of course be the customer). It includes addresses of both the customer and the customer's designees. The addresses preferably include a postal code for the country, such as the well-known ZIP code used in the U.S. This postal code is a preferred way of identifying the location where the photo product is to be delivered, in order to allow the service provider to select the regional printing location 140 which is closest to the designee's location. In a preferred embodiment, the customer also identifies an account to be debited to pay for the photo product(s) to be purchased. Often this will be a credit card having a payment identifier that specifies the account of the customer to be charged or debited. Frequently, this will be in a financial institution. The payment identifier can be a credit card number that specifies a particular credit card account. As used in this specification, a credit card will also include a debit card.

In block 104, a user service account is established for the customer. The information stored in the service account includes the information entered by the customer in block 102. The service account information includes the delivery location address, with the postal code. This service account information will later be augmented by additional information listing the photo product options selected by the customer, and image identifiers that correspond to image files to be uploaded from the customer's computer 10 to the selected regional printing center 140. FIG. 5, to be described later, provides an example of the service account information. The billing information (e.g. credit card number) and other sensitive information provided in the service account can be encrypted to prevent discovery and unauthorized use. The service account information is preferably stored as part of the electronic database 44 of the central fulfillment center 40. Alternatively, it is possible for some of the service account information to be stored in the customer's home computer system 10, for example on the hard drive 20. For example, the image identifiers corresponding to images to be uploaded can be stored using hard drive 20.

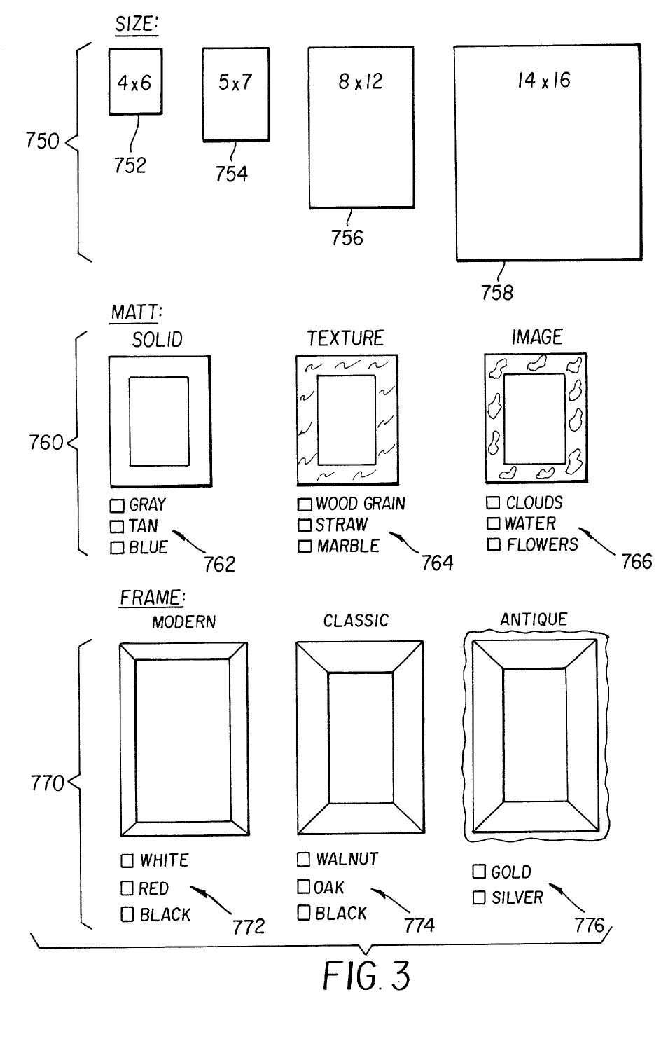

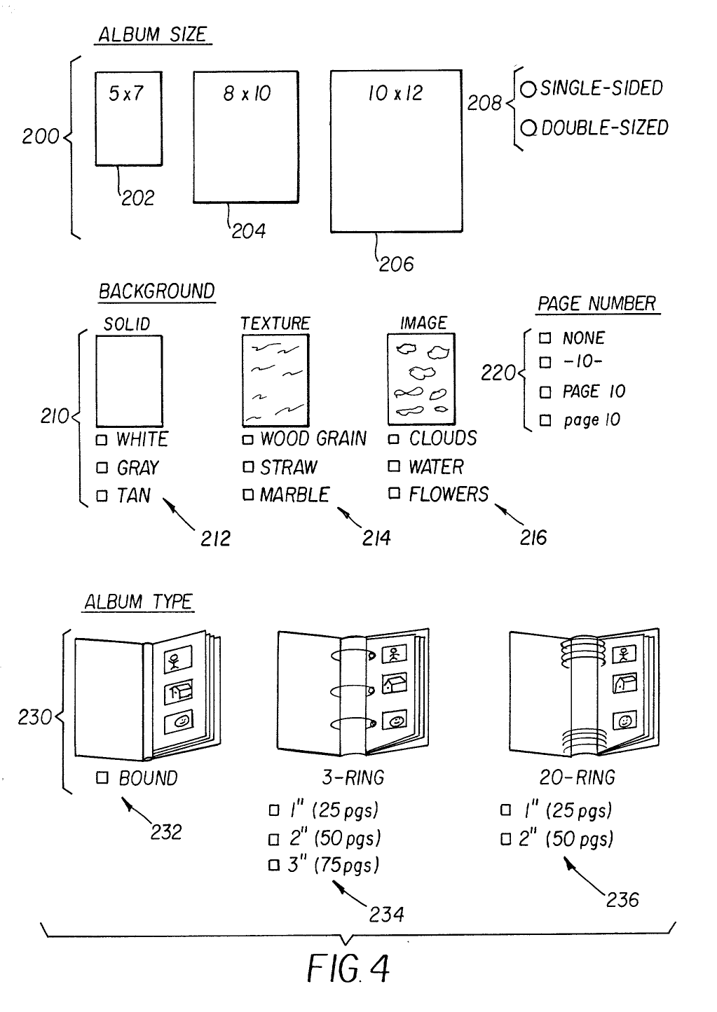

In block 106, the central fulfillment center 40, via the network service 42, provides the customer with a menu of photo products 66 that are available for customization and purchase, such as standard service prints, framed hardcopy prints as depicted in FIG. 3, and customized photo albums as depicted in FIG. 4. In block 108 the customer selects what type of products (e.g. standard service prints, framed hardcopy prints, or customized photo albums) to purchase.

In block 110, the central fulfillment center 40, via the network server 42, provides a menu of customizable features for the type of photo product(s) selected by the user. This menu is displayed on display monitor 14 of the home computer system 10. In block 112, the customer selects preferred features for the type of product(s) they selected in block 108.

The options for standard prints include providing the prints in various sizes (e.g. 3″×5″, 4″×6″, etc.) and various surface finishes (e.g. glossy, matte finish, etc.). The standard prints can also include text, such as the date the picture was captured or printed. The date the pictures were captured can be obtained from the digital image file to be uploaded, if the picture was taken by a digital camera or by an APS film camera having a real-time clock. The user can select whether or not to include this date stamp, where to position the text (e.g. on the front at the lower left, or on the back of the print.). The user can also select the color (e.g. white or yellow) and the font (e.g. Helvetica or Script) for the date stamp.

FIG. 3 depicts print options that can be selected by the user. The options include selecting the size of the print from a plurality of print sizes 750, including, for example, 4″×6″ size 752, 5″×7″ size 754, 8″×10″ size 756, and 14″×16″ size 758. The user selects the size by selecting the appropriate print size icon (e.g. icon 752, 754, 756, or 758). The options also include selecting a print matte border style from a plurality of styles 760, including solid mattes 762 in gray, tan, and blue, textured mattes 764 in wood grain, straw, or marble, and background image mattes 766 including clouds, water, or flowers. The user selects the matte by selecting the appropriate radio button (e.g. one of buttons 762, 764, or 766) for their preferred matte style. The user can also optionally select a picture frame style from a variety of styles 770, including modem styles 772 in white, red, and black, classic styles 774 in walnut, oak, and black, and antique styles 776 in gold and silver. The user selects the picture frame style by selecting the appropriate radio button (e.g. one of buttons 772, 774, or 776) for their preferred frame style. Of course, many more size, matte, and frame options can be presented to the user using various types displays, such as pull-down menus, scroll bars, etc. The selected combination of print size, matte style and frame style is then presented to the user. For example, if the user selects a classic walnut frame with a blue matte, the central fulfillment center 40, via the network server 42, would present to the user an image depicting this combination for the user to review.

FIG. 4 depicts user selectable album options. The options include selecting the size of the album from a plurality of sizes 200, including 5″×7″ size 202, 8″×10″ size 204, and 10″×12″ size 206. The user selects the size by selecting the appropriate print size icon (e.g. icon 202, 204, or 206). The options also include using radio buttons 208 to select single-sided pages (e.g. print only on one side of the album page) or double-sided pages. The options further include selecting a preferred background style from a plurality of styles 210, including solid backgrounds 212 in white, gray, or tan, textured backgrounds 214 in wood grain, straw, or marble, and background images 216 including clouds, water, or flowers. The user selects the background style by selecting the appropriate radio button (e.g. one of buttons 212, 214, or 216). The user then selects whether to include a page number from a plurality of options using radio buttons 220. The options include no page numbers and several different styles of page numbers. The color, size, and font of the text used for the page numbers and image captions could also be selected using a separate menu (not shown). Finally, the user selects an album type from a plurality of album types 230. The album type is selected by the user by selecting one of the radio buttons for bound albums 232, 3-ring albums 234 (including 1″, 2″, and 3″ thick 3-ring albums) or 20-ring albums 236 (including 1″ and 2″ thick albums). Of course, many more size, background, and album type options can be presented to the user using various types displays, such as pull-down menus, scroll bars, etc. The selected combination of album size, background, page numbers, and album type is then presented to the user. For example, if the user selects a 8″×10″ double-sided album pages in a 3-ring, 2″ thick binder with a marble texture background and a particular page number style, the central fulfillment center 40, via the network server 42, presents to the user an image depicting this combination for the user to review.

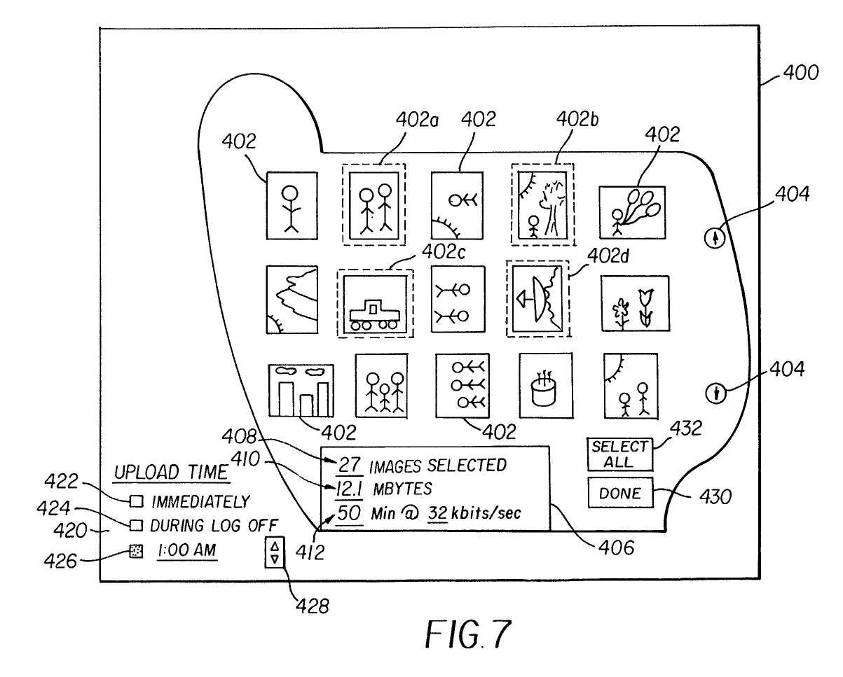

In block 114 of FIG. 2, the customer selects images to be uploaded in order to be utilized to produce their selected photo products, as well as an upload time option. In a preferred embodiment, the CPU 12 displays on the display monitor 14 a display screen 400 as shown in FIG. 7. The display screen 400 includes a two-dimensional array of thumbnail images 402 obtained from an image input device, such as the digital camera 6, the CD reader 2, or the hard drive 20. The thumbnail images 402 preferably are thumbnail images stored within the Exif/JPEG image files provided by the digital camera 6 or other input device. The user selects all of the images, or a subset of the images, by clicking the mouse 18 on the “select all” icon 432, or on any number of thumbnail images 402. FIG. 7 shows that four thumbnail images 402a, 402b, 402c, and 402d (which are outlined) have been selected.

In order to select desired images from a large number of thumbnail images 402, arrow controls 404 on the right portion of the display screen 400 enable the user to scroll through the larger number of thumbnail images 402 to view a group of the thumbnail images 402 (e.g., 15 thumbnail images) at a time. The user can then select additional images (e.g., three images) to be printed by again pressing the control key or the shift key on the keyboard 16 while clicking the mouse 18 on any number of thumbnail images 402.

The image identifiers corresponding to the customer's selected images, the customer's selected upload time, and the customer's selected photo product options are added to the user's service account information. The image identifier can be the image file name, if all images to be uploaded are located in the same folder or directory on the user's computer 10, such as the same folder or directory on the hard drive 20. Alternatively, the image identifier can be a complete pathname specifying the storage device and the directory structure needed to locate each image. Alternatively, the image identifier can be a data string that matches a data string within the corresponding image file, such as an GUID (globally unique ID), and image number, an image title, or the like.

As the user selects images, an image data upload indicator 406 displays the number of images selected for uploading 408 (e.g. 27 images), as well as other information such as the total size of all of the selected files 410 (e.g. 12.1 Mbytes total for all selected images) and the estimated time for image uploading 412 (e.g. 50 minutes) given the data rate of the user's modem 22 (e.g. 32 kbit/sec average net upload speed).

In block 114, the user also selects their preferred upload time using upload time selector 420 in FIG. 7. The options include immediately after completing the order process 422, waiting until the user logs off his computer 424, or waiting until a particular time selected by the user 426. The user may enter a different time, in place of the default time of 1:00 am local time, using the keyboard 16 or by clicking the mouse 18 on the up/down arrows 428. In alternative embodiments, the user may also select a time for uploading images from a list of preferred times provided by the fulfillment center 40, or after a preselected number of minutes of inactivity (e.g. after 10 minutes of inactivity), or concurrently in the background as a low priority task. Finally, the user clicks on the “done” icon 430. At this point, the user is presented with one or more display screens (not shown) depicting the final products to be delivered, and confirming the cost of the products. The user then approves the order and may be allowed to log off of the Internet site.

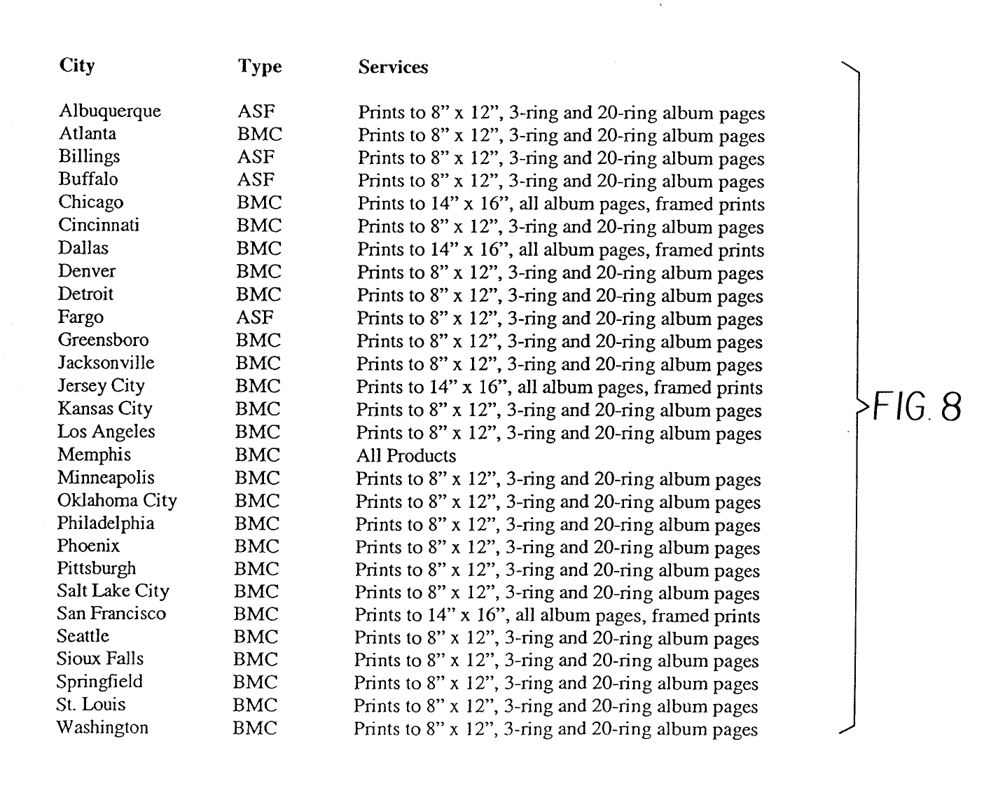

In block 116, the production controller 52 determine the particular regional printing location(s) that will produce the photo products ordered by the customer. In one preferred embodiment, this is done by selecting the nearest regional printing center from the list of regional printing centers provided in FIG. 8. Each regional printing center is located in a city corresponding to a type of U.S. postal service bulk mail center (BMC) or auxiliary service facility (ASF). Each regional printing center can produce the products listed in FIG. 8. For example, the central fulfillment center is located in Memphis and can produce all of the types of products offered by the photo service provider. The regional printing center located in Jersey City can produce prints up to 14″×16″ in size, and all types of album pages and framed prints. The regional printing center located in Atlanta can produce prints up to 8″×12″ in size, as well as 3 and 20 ring album pages.

The regional printing center is selected by assigning, to each city in FIG. 8, a list of 3-digit ZIP Code prefixes. This assignment is done using the official national zone charts, which are available from the United States Postal Service (USPS) as a software package. These charts identify the distance codes, or “zones” for every pair of ZIP codes in the U.S. Zone charts were produced by the USPS using geological survey files of established latitude and longitude coordinates to determine the distance between the originating ZIP code (e.g. the ZIP code of each regional printing center listed in FIG. 8) and the destination ZIP code (e.g. the ZIP code of the designee(s) shipping address provided in the service account information in FIG. 5). The regional printing center selected is the regional printing center having the lowest zone number that is able to produce the selected photo product(s). If, for some reason, this particular regional printing center is not operational, the next closest regional printing center is selected.

In block 118, the central fulfillment service, via network server 42, communicates the order information to the regional printing location selected in block 116. This can be accomplished by communicating the appropriate service account information listed in FIG. 5.

As shown in the example depicted in FIG. 5, the service account information includes (lines 3-13) the user name, password, e-mail address, and billing information (credit card number, expiration date) and billing address. The service account information also includes (lines 15-31) the name and mailing address of several user designees, including the ZIP code of each designee.

The service account information also includes a list of product IDs for the several products ordered by the user, each having a different identifier (ID). The products include Product ID-1 (lines 33-45) which specifies a customized album, Product ID-2 (lines 47-54) which specifies a framed print, and Product ID-3 (lines 56-63) which specifies customized service prints. The album related information (lines 33-45) includes the page size, album type, and background style selected. It also includes page number information, such as the style, font, and color of the text, and the last page number printed. The last page number information is updated each time new album pages are printed. It can be used to automatically tell the user when an album has been filled, and a new album needs to be purchased. The album related information also includes a list of image numbers (line 43) to be included in the album. These image numbers correspond to image identifiers listed in the Image upload list section (lines 67-85) of FIG. 5. The album related information also indicates that designee #1 should receive the order (line 44) and the order status (line 45). The order status indicates that this photo product has been ordered by the user, but not yet fulfilled. Once fulfilled, the status will be updated to indicate that this order has been completed.

The framed print information (lines 47-54) specifies the frame size, frame style and color, and matte style. It also includes a list of image numbers (line 52) to be used to produce the framed print. This image number (Image number 3) corresponds to image identifier listed for image number 3 in the Image upload list section (line 50) of FIG. 5, which is the image identified as /D/DCIM/100DC280/DCP_{—}0017.JPG, the path name of the image on the home computer system 10. The information also indicates that designee #2 should receive the order (line 53) and the order status (line 54).

The service print information (lines 56-63) specifies the print size, print finish, and the location, font style, size, and color of the date to be overlaid in the print. It also includes a list of image numbers (line 61) to be printed. The information also indicates that designee #3 should receive the prints (line 62) and the order status (line 63). The service print information could also specify other text or graphics selected by the user that should be added to the images when they are printed.

The upload time information (lines 65-66) indicates the user selected upload time. At line 66, it indicates an upload time of 1:00 am eastern standard time (EST). The upload time information could alternatively indicate “immediately” or “as user logs off”.

The image upload list (lines 67-85) provides a list of image identifiers corresponding to the images to be uploaded, which were selected by the user in block 114. The upload list provides a reference number (e.g. Image 1) and a pathname to the image file on the home computer system 10 in order to locate the image to be uploaded (e.g. /D/DCIM/100DC280/DCP_{—}0012.JPG). This pathname points to the JPEG/Exif image named DCP_{—}0012.JPG located in the folder named 100DC280 within the folder named DCIM on the “D” drive of the user's computer 10, which for example can be the drive name used for the digital camera 6. The upload list also includes an upload status for the image (e.g. “To be uploaded”). As the images are later uploaded, this status is updated. In case of interruptions or errors, only those images not yet uploaded will need to be transferred.

The service account information is stored in electronic database 44. Alternatively, some or all of the service account information could instead be stored on hard drive 20, or could be duplicated on hard drive 20 of home computer system 10. In block 118, the appropriate subset of the service account information is communicated to the particular regional printing location 140 that was selected in block 116. For example, in block 116 the Buffalo regional printing center was selected to print and ship the album defined as product ID-1, because this product will be shipped to Rochester, N.Y. Therefore, the central fulfillment center 40 communicates to the Buffalo regional printing center the mailing address of designee #1 (lines 15-19 in FIG. 5) and the information, which defines product ID-1 (lines 34-45). In block 116 the Chicago regional printing center was selected to print and ship the framed print defined as product ID-2, because this product will be shipped to Oconomowoc, Wis. Therefore, the central fulfillment center 40 communicates to the Chicago regional printing center the mailing address of designee #2 (lines 21-25 in FIG. 5) and the information which defines product ID-2 (lines 47-54). Finally, in block 116 the Los Angeles regional printing center was selected to print and ship the service prints defined as product ID-3, because this product will be shipped to Irvine, Calif. Therefore, the central fulfillment center 40 communicates to the Los Angeles regional printing center the mailing address of designee #3 (lines 27-31 in FIG. 5) and the information which defines product ID-1 (lines 57-63).

In block 120, at the indicated time, the digital images are uploaded either to the fulfillment center 40, or to the particular regional printing location 140 that was selected to print the image. The upload time is the time selected by the user in block 114. In some cases, this is immediately after the user confirms the order. In other cases, the images are uploaded when the user initiates the process of shutting down their computer. In this situation, the images are transferred, and then the shut down process is completed. In other cases, the images are transferred at a specified time, typically at night when the user's computer and phone line are unlikely to be needed. Of course, this requires that the user's computer remain powered on, or in a low power standby state until it is “woken up”, for example by the task scheduler program in Microsoft Windows 98.

Typically, the modem connection 22 between the home computer system 10 and the network service provider 30 provides a data rate that is much lower than the data rate provided by the channel 36 between the central fulfillment center 40 and the regional printing locations 140. Therefore, it is preferable for each digital image to be uploaded only once from the home computer system 10. For example, if the same digital image (e.g. Image 1 defined in line 68 of FIG. 5) is used in two or more photo products produced at different locations (e.g. Album ID-1 produced at the Buffalo regional printing center and service print ID-3 produced at the Los Angeles regional printing center), it is preferable to transfer the image from the home computer system 10 to the fulfillment center 40 for storage in electronic database 44. The digital image is then transferred from network server 42 via channel 36 to network server 142 of each of the particular regional printing centers 140 (e.g. Buffalo and Los Angeles) which will produce photo products using this particular image.

If, on the other hand, one or more digital image files are to be used only by the particular printing location, it is preferred that the digital images be transferred from the home computer system 10 directly to the particular regional printing location 140 that will produce the photo products. For example, Images 17-18 (lines 84-85 in FIG. 5) are used only to produce service prints for product ID-3. These images can be uploaded directly from home computer system 10 to the Los Angeles regional printing location 140. In this case, the digital images are transferred from the home computer system 10 to the network address of the selected regional printing center 140. This is preferably done by the central fulfillment center 40 communicating with the user's home computer system 10 to provide the network address of the selected regional printing location 140. Alternatively, the central fulfillment center 40 can communicate the address of the user's home computer system 10 to the selected regional printing center 140, and instruct it to initiate the uploading of the digital image files from the home computer system 10 at the appropriate time. The printing controller 152 in the particular regional printing location 140 is responsible for monitoring the image uploading, and for communicating the status of this uploading to the fulfillment center 40 when problems occur.

As the images are uploaded, the image upload status in the service account information (lines 67-85 in FIG. 5) are updated to indicate which images have been successfully uploaded. In the unlikely event that the consumer needs the phone line while the image uploading is being conducted, the uploading will terminate. This can be noted by the user's computer 10 or the network server 42, which can automatically re-establish the connection at a later time, via the network service provider 30, and upload the images having a status of “To be uploaded”.

After all the images are uploaded, in block 122, the central fulfillment center 40 can send a message to the user's email account to confirm receipt of the images, and the appropriate printing controllers 152 in the appropriate regional printing locations produce the photo products using the uploaded images and the service account information.

For the example in FIG. 5, the service prints for product ID-3 are printed using the color hardcopy printer 154 located in the Los Angeles regional printing center to produce hardcopy prints 58. The hardcopy prints 58 use the size and finish specified in lines 58-59 of FIG. 5. Before printing, each digital image is overlaid with the date stamp as specified in line 60 of FIG. 5.

If the user has ordered album pages (e.g. product ID-1 in FIG. 5), the uploaded digital images can be automatically arranged on the pages by printing controller 152 and printed by color hardcopy printer 154 to produce album pages 56 as described in commonly assigned U.S. patent application Ser. No. 09/347,310, filed Jul. 2, 1999 to Loui et al.; U.S. patent application Ser. No. 09/199,724, filed Nov. 25, 1998 to Shaffer et al; and Ser. No. 09/199,639, filed Nov. 25, 1998 to Shaffer et al., the disclosures of which are herein incorporated by reference. The last page number (line 42) in the service account information depicted in FIG. 5 is updated to reflect the number of album pages that will be produced to show the uploaded images. Alternatively, as part of block 114, the user can manually arrange the images on the pages and also select preferred colors, messages, logos, etc.

In one embodiment, the album page background image data providing the background selected by the user in block 112 is communicated from the database 44 of the central fulfillment center 40 to the printing controller 152 in the particular regional printing location 140 along with the required service account information. The digital images which were uploaded from the user's home computer system 10 directly to the particular regional printing location 140 are combined with the album page background image data by the printing controller 152 in order produce the album pages.

In an alternative embodiment, the digital images are uploaded to the fulfillment center 40 and are combined with the album page background image data, corresponding to the background selected by the user in block 112, by the production controller 52 in order produce the album page image files. These album page image files are then communicated from the fulfillment center 40 to the printing controller 152 in the particular regional printing location 140 along with the required service account information.

If the user has ordered a low volume product, such as a PictureCD 78 or custom album cover 62, the product is produced at the central fulfillment center 40. The production controller 52 uses an album label printer 60 to produce a custom album cover 62, into which album pages 56 produced by color hardcopy printer 54 are inserted. The production controller uses a CD Writer 76 to produce a Kodak PhotoCD 78 containing digital images. In some situations, it is preferable to also produce the rest of the order (e.g. service prints ordered at the same time) at the central fulfillment center 40, so that the entire order can be shipped together. Alternatively if the service prints can be produced and shipped separately, at the closest regional printing location to the designee's ZIP code.

To produce framed prints (e.g. product ID-2 in FIG. 5), the digital images are printed at the closest regional printing location 140 capable of producing framed prints (e.g. the Chicago regional printing center) using color hardcopy printer 154 to produce hardcopy prints 58. Each hardcopy print 58 includes the user selected matte border, for example the solid blue border specified in line 31 of FIG. 5. Each hardcopy print 58 is then framed using the appropriate frame 68, for example the classic—walnut frame specified in line 50 of FIG. 5.

In block 124, the printing controller 152 in the particular regional printing location 140 in FIG. 1 controls the shipping label printer 170 to produce the shipping label 74 using the shipping address of the customer or customer's designee provided in the service account information (FIG. 5). The shipping label 74 is attached to the shipping container 64 that is used to ship the photo product 66. Alternatively, the production controller 152 in the fulfillment center 40 controls the shipping label printer 70 to produce the shipping label 74. The shipping label 74 is attached to the shipping container 64 that is used to ship the photo product 66.

In some embodiments, the label also includes a postage stamp marking providing the appropriate postage needed to ship the product from the regional printing center to the designee. This postage can be automatically calculated by the printing controller 152, using the weight of the shipping container including the photo product(s) and the zone determined earlier as described in relation to block 116. The label may optionally include a thumbnail of one or more of the uploaded digital images. The postage stamp marking may include one of these thumbnail images.

In block 126, the customer account provided in the service account information (FIG. 5) is billed for the order. At this point, the financial institution having the customer's account designates such funds for transfer to the product provider or seller.

In block 128, the photo product(s) 66 incorporating the digital images uploaded from the home computer system 10 are delivered to the customer or the customer's designee. The term “delivery” means that the photo product(s) 66 can be shipped to the customer or the customer's designee by the U.S. Postal Service (USPS) or by a carrier service, such as the United Parcel Service (UPS) or Federal Express. Alternatively, the photo product 66 can be delivered to a location such as the store, where the customer can pick it up. In this case, the billing provided in step 126 can be delayed until the customer picks up the photo product 66, and the customer can then pay for the photo product 66 using cash, check, or a charge/debit card.

After the photo products are shipped to the user in block 124, the digital images uploaded by the user in step 116 can be deleted from the printing controller 152 in FIG. 1. The digital images are retained in the electronic database 44, however, if the user requested that they be maintained for long term storage and “sharing” via the Internet. The service account information in FIG. 5 is retained, so that it can be used for subsequent orders by the same customer. This typically occurs many weeks or months later, when the user wants to print additional images. At this time, the customer again logs onto the Internet site and enters their name and password, similar to block 100. Alternately, the home computer system 10 can include a “cookie” created and stored on hard drive 20 when the user first accessed the Internet site in step 100. This “cookie” can automatically identify the user account. In response, the central fulfillment center accesses, from the electronic database 44 in FIG. 1, the service account information for the customer. The network server 42 provides a display for the user based on the Product ID information stored in the user's service account. For example, if the user had selected an 8″×10″ double-sided album pages in a 3-ring, 2″ thick binder with a marble texture background and a selected page number style in step 112, the Internet server 42 would also present to the user an image depicting this combination for the user to review. The network server 42 also allows the user to select new types of products to purchase, and to customize the products, as provided earlier in blocks 106 to 112.

The customer then selects another set of images to be uploaded, as described earlier in relation to block 114. As in block 114, this can be done by selecting to upload all the images from a particular CD inserted in CD reader 2 or stored in digital camera 6 or by individually selecting images to be uploaded. The user can use their default upload time stored in their service account, or can select a different upload time. The service account information is updated to reflect the new order information. At this point, the customer can be presented with one or more display screens showing the final products to be delivered, and confirming the cost of the products. The user then approves the order and may be allowed to log off of the Internet site.

The production controller 52 then determines the particular regional printing location(s) that will produce the photo product(s) ordered by the user, as described earlier in relation to block 116, and communicates the order information to the regional printing location(s), as described earlier in relation to block 118. At the appropriate time, this second group of digital images is uploaded, as described earlier in relation to block 120. The printing controller 152 then produces the newly ordered photo products using this second group of images, and the service account information stored in electronic database 44. If the user has ordered an album, the last page number (line 42) in the service account information depicted in FIG. 5 is updated to reflect the number of album pages that will be produced to show the uploaded images. If the number of new album pages to be produced will exceed the capacity of the customer's current album (e.g. if the print count will be 54, which is more than 50 pages for the 2″ thick binder in FIG. 4), the user may be advised that a new album will be ordered to store some of the new album pages, and the page numbers printed on the album pages are numbered accordingly. In the above example, the last 4 pages (e.g. prints 51 to 54) are given page numbers 1 to 4 and provided in a new album, while the other pages will be included in the earlier 3-ring album provided as part of the earlier order.

Finally, the shipping label 74 is produced and attached to the shipping container 64, the customer account is billed for the order, and the photo product(s) incorporating the second group of images are shipped to the customer or customer's designee, as described earlier in relation to blocks 124 to 128.

The user can of course repeat this process many times, with new groups of digital images, to simply and easily obtain similarly customized photo products. For example, the user can, over the course of several years, obtain a set of frame prints having similar frame styles and matte colors, without needing to re-enter, or even remember, the choices they had made for their earlier orders.

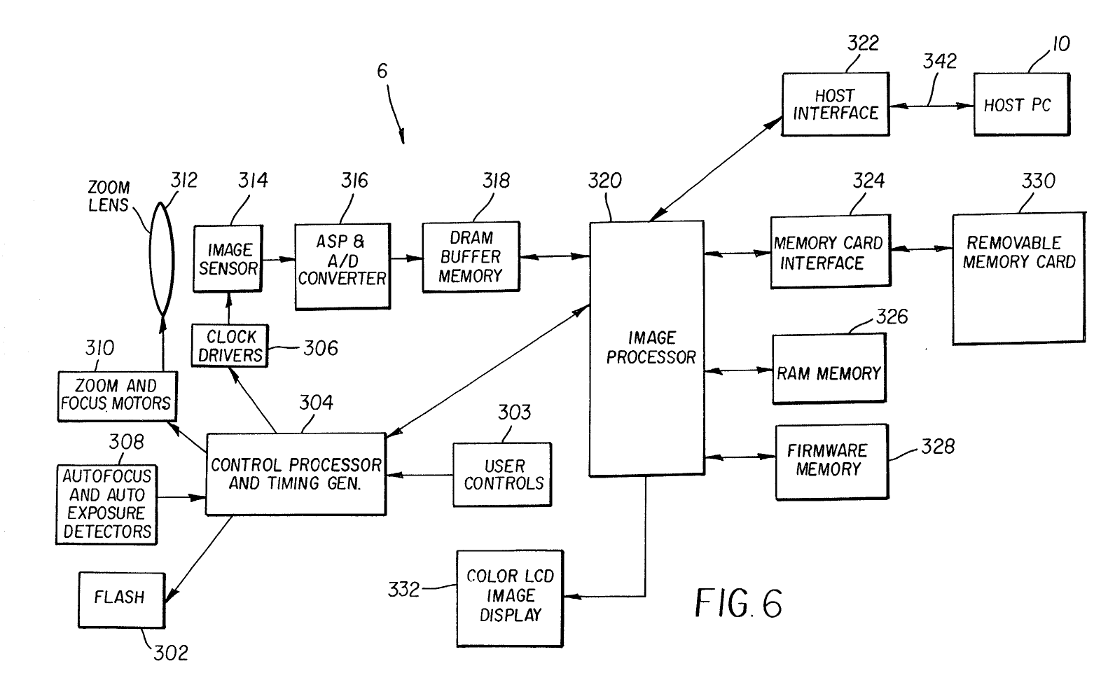

FIG. 6 is a block diagram showing the digital camera 6 in more detail. The digital camera 6 produces digital images that are stored on the removable memory card 330. The digital camera 6 includes a zoom lens 312 having zoom and focus motor drives 310 and an adjustable aperture and shutter (not shown). The zoom lens 312 focuses light from a scene (not shown) on an image sensor 314, for example, a single-chip color CCD image sensor, using the well known Bayer color filter pattern. The image sensor 314 is controlled by clock drivers 306. The zoom and focus motors 310 and the clock drivers 306 are controlled by control signals supplied by a control processor and timing generator circuit 304. The control processor and timing generator 304 receives inputs from autofocus and autoexposure detectors 308 and controls a flash 302. The analog output signal from the image sensor 314 is amplified and converted to digital data by the analog signal processing (ASP) and analog-to-digital (A/D) converter circuit 316. The digital data is stored in a DRAM buffer memory 318 and subsequently processed by a processor 320 controlled by the firmware stored in the firmware memory 328, which can be flash EPROM memory.

The processed digital image file is provided to a memory card interface 324 which stores the digital image file on the removable memory card 330. Removable memory cards 330 are known to those skilled in the art. For example, the removable memory card 330 can include memory cards adapted to the CompactFlash Specification Version 1.3, published by the CompactFlash Association, Palo Alto, Calif., Aug. 5, 1998. Other types of digital memory devices, such as magnetic hard drives, magnetic tape, or optical disks, could alternatively be used to store the digital images.

The processor 320 performs color interpolation followed by color and tone correction, in order to produce rendered sRGB image data. The rendered sRGB image data is then JPEG compressed and stored as a JPEG image file on the removable memory card 330. The processor 320 also creates a “thumbnail” size image that is stored in RAM memory 326 and supplied to the color LCD image display 332, which displays the captured image for the user to review. The electronic camera 6 is controlled by user controls 303, such as a series of user buttons including a shutter release (e.g., capture button) (not shown) which initiates a picture taking operation. The graphical user interface displayed on the color LCD image display 332 is controlled by the user interface portion of the firmware stored in the firmware memory 328.

After a series of images have been taken and stored on the removable memory card 330, the removable memory card 330 can be inserted into the card reader (not shown) in home computer 10. Alternatively, an interface cable 342 from can be used to connect between the host interface 322 in the electronic camera 6 and the CPU motherboard 12 in home computer system 10. The interface cable 342 can conform to, for example, the well-known universal serial bus (USB) interface specification.

The digital camera 6 can create an image utilization file listing the images to be printed, as described in commonly assigned U.S. patent application Ser. No. 08/977,382, filed Nov. 24, 1997 to Parulski et al., the disclosure of which is herein incorporated by reference. This image utilization file can digital print order format (DPOF) file. The DPOF file can be used to automatically identify the digital images to be uploaded, rather than manually identifying the images on the display monitor 14 as described earlier in relation to block 114 in FIG. 2.

The digital camera 6 can also store a service account identifier in the firmware memory 328, as described in commonly assigned U.S. patent application Ser. No. 09/534,469, filed Mar. 24, 2000 to Parulski, the disclosure of which is herein incorporated by reference. The service identification number can then be stored onto the removable flash memory 330, either as part of each image file, or as a separate digital record, so that it can be used to automatically access the service account for the user.

A computer program product can include one or more storage media, for example; magnetic storage media such as magnetic disk (such as a floppy disk) or magnetic tape; optical storage media such as optical disk or optical tape, or machine readable bar code; solid-state electronic storage devices such as random access memory (RAM), or read-only memory (ROM); or any other physical device or media employed to store a computer program having instructions for practicing a method according to the present invention.

The invention has been described in detail with particular reference to certain preferred embodiments thereof, but it will be understood that variations and modifications can be effected within the spirit and scope of the invention.

For example, the invention can be applied to a system for printing hard copies of various types of digital documents containing images, graphics, and/or text. In such applications, the plurality of hard copy products provided by the service provider can include reports, greeting cards, booklets, flyers, etc. The hard copy printers located at each particular printing location would produce these types of hard copy products. The user would identify the designee's location, including the ZIP code, and upload their digital document(s). At the particular printing location automatically selected by the service provider, the digital document(s) uploaded by the user would be used to produce the user-selected hard copy products.

PARTS LIST

| | |
|---|---|
| 2 | CD reader |
| 4 | color scanner |
| 6 | digital camera |
| 10 | home computer system |
| 12 | CPU motherboard |
| 14 | display monitor |
| 16 | keyboard |
| 18 | mouse |
| 20 | hard drive |
| 22 | dial-in modem |
| 30 | Internet service provider |
| 32 | modem |
| 34 | computers/routers |
| 36 | channel |
| 40 | fulfillment center |
| 42 | network server |
| 44 | electronic database |
| 46 | billing system |
| 48 | bill issuing |
| 52 | production controller |
| 54 | color hardcopy printer |
| 56 | album pages |
| 58 | hardcopy prints |
| 60 | album label printer |
| 62 | custom album cover |
| 64 | shipping container |
| 66 | photo product |
| 68 | frames |
| 70 | shipping label printer |
| 74 | shipping label |
| 76 | CD writer |
| 78 | PictureCD |
| 100 | block |
| 102 | block |
| 104 | block |
| 106 | block |
| 108 | block |
| 110 | block |
| 112 | block |
| 114 | block |
| 116 | block |
| 118 | block |
| 120 | block |
| 122 | block |
| 124 | block |
| 126 | block |
| 128 | block |
| 140 | printing location |
| 142 | network server |
| 152 | printing controller |
| 154 | color hardcopy printer |
| 170 | shipping label printer |
| 174 | shipping label |
| 202 | album size |
| 204 | album size |
| 206 | album size |
| 208 | radio buttons |
| 210 | background style |
| 212 | solid background style |
| 214 | textured backgrounds |
| 216 | background images |
| 220 | radio button |
| 230 | album types |
| 232 | bound albums |
| 234 | 3-ring albums |
| 236 | 20-ring albums |
| 302 | flash |
| 303 | users controls |
| 304 | control processor and timing generator circuit |
| 306 | clock drivers |
| 308 | autofocus and autoexposure detectors |
| 310 | zoom and focus motor drives |
| 312 | zoom lens |
| 314 | image sensor |
| 316 | ASP&A/D converter |
| 318 | DRAM buffer memory |
| 320 | processor |
| 322 | host interface |
| 324 | memory card interface |
| 326 | RAM memory |
| 328 | firmware memory |
| 330 | removable memory card |
| 332 | color LCD image display |
| 342 | interface cable |
| 400 | display screen |
| 402 | thumbnail images |
| 402a | thumbnail image |
| 402b | thumbnail image |
| 402c | thumbnail image |
| 402d | thumbnail image |
| 404 | arrow controls |
| 406 | upload indicator |
| 408 | number of images |
| 410 | total file size |
| 412 | transfer time |
| 420 | upload time selector |
| 422 | immediate option |
| 424 | logoff option |
| 426 | time option |
| 428 | up/down arrows |
| 430 | done icon |
| 432 | select all icon |
| 750 | print sizes |
| 752 | print size |
| 754 | print size |
| 756 | print size |
| 758 | print size |
| 760 | maffe styles |
| 762 | solid mattes |
| 764 | textured mattes |
| 766 | background image mattes |
| 770 | picture frame styles |
| 772 | modem picture frame style |
| 774 | classic picture frame style |
| 776 | antique picture frame style |

What is claimed is:

1. A method of ordering a photo product to be printed at a selected location and delivered to a designee, comprising the steps of:
(a) a user communicating with a service provider that offers a plurality of photo products and selecting a particular photo product to incorporate a digital image provided by the user;
(b) the user providing an identification of the designee's location where the selected photo product is to be delivered;
(c) the service provider automatically selecting, from a plurality of printing locations, a particular printing location based on the identification of the designee's location;
(d) using a communications network to transfer the digital image from the user to the particular printing location; and
(e) printing the selected photo product at the particular printing location and delivering the photo product to the designee.

2. The method of claim 1 wherein the user makes payment via the network for the photo product.

3. The method of claim 1 wherein the identification of the designee's location is the designee's zip code.

4. The method of claim 3 wherein the photo product is delivered to the designee by the U.S. postal service.

5. The method of claim 1 wherein the service provider communicates a network address of the particular printing location to the user.

6. The method of claim 5 wherein the user transfers the digital image to the network address communicated by the service provider.

7. The method of claim 1 wherein the photo product includes at least one album page, the digital image is transferred from the user directly to the particular printing locations, and album page background image data is communicated from the service provider to the particular printing location in order to produce the at least one album page.

8. A method of ordering a photo product to be printed at a selected location and delivered to a designee, comprising the steps of:
(a) a user communicating with a service provider that offers a plurality of photo products and selecting a particular photo product to incorporate a digital image provided by the user and sending the digital image to the service provider;
(b) providing an identification of the designee's location where the selected photo product is to be delivered and the service provider selecting from a plurality of printing locations a particular printing location;
(c) the service provider sending the digital image to the particular printing location; and
(d) printing the selected photo product at the particular printing location and delivering the photo product to the designee.

9. The method of claim 8 wherein the user makes payment via the network for the photo product.

10. The method of claim 8 wherein the identification of the designee's location is the designee's postal code.

11. The method of claim 10 wherein the postal code is a zip code.

12. The method of claim 8 wherein the service provider processes the digital image and sends the processed digital image to the particular printing location.

13. The method of claim 12 wherein the processing includes combining the digital image with a background image provided by the service provider.

14. A method of ordering a photo product to be printed at a selected location and delivered to a designee, comprising the steps of:
(a) a user communicating with a service provider that offers a plurality of photo products and selecting a particular photo product to incorporate a plurality of digital images provided by the user;
(b) the service provider producing a representation of the photo product and sending such representation to the user;
(c) the user approving an order for the photo product depicted in said representation, and providing an identification of the designee's location where the selected photo product is to be delivered;
(d) the service provider using said identification of the designee's location to select, from a plurality of printing locations, a particular printing location;
(e) using a communications network to transfer the plurality of digital images to the particular printing location; and
(f) printing the selected photo product at the particular printing location and delivering the photo product to the designee.

15. The method of claim 14 wherein the plurality of photo products is selected from a group including an album page containing two or more digital images provided by the user.

16. The method of claim 14 wherein the plurality of photo products includes prints having a plurality of different sizes.

17. The method of claim 14 further including the steps of a user providing a payment identifier specifying an account to be charged for producing and delivering the photo product.

18. A method of ordering a photo product to be printed at a selected location and delivered to a designee, comprising the steps of:
(a) a user communicating with a service provider that offers a plurality of photo products and selecting a particular photo product to incorporate a digital image provided by the user;
(b) the user providing an identification of the designee's location where the selected photo product is to be delivered;
(c) the service provider selecting, from a plurality of printing locations, a particular printing location based on the identification of designee's location;
(d) using a communications network to transfer the digital image from the user to the particular printing location at a suitable time; and
(e) printing the selected photo product at the particular printing location and delivering the photo product to the designee.

19. The method of claim 18 wherein the suitable time is a time selected by the user.

20. The method of claim 18 wherein the suitable time is a time selected for efficient transfer over the channel.

21. The method of claim 18 wherein the suitable time is selected by a user from a plurality of service times provided by the provider.

22. A method of ordering a photo product to be printed at a selected location and delivered to a designee, comprising the steps of:
(a) a user communicating with a service provider and selecting a particular photo product to incorporate a digital image provided by the user;
(b) the user providing an identification of the designee's location where the selected photo product is to be delivered;
(c) the service provider automatically selecting, from a plurality of printing locations, a particular printing location based on the identification of the designee's location;
(d) using a communications network to transfer the digital image from the user to the particular printing location; and
(e) printing the selected photo product at the particular printing location
(f) printing a shipping label including the identification of the designees location
(g) attaching the shipping label to a shipping container for holding the photo product, and
(h) delivering the shipping container to the designee.

23. The method of claim 22 wherein step (f) includes printing a postage stamp on the shipping label.

24. The method of claim 23 wherein the postage stamp depicts at least a portion of the digital image.

25. The method of claim 22 wherein the identification of the designee's location is the designee's zip code.

26. The method of claim 23 wherein the photo product is delivered to the designee by the U.S. postal service.

27. A method of ordering a hard copy product to be printed at a selected location and delivered to a designee, comprising the steps of:
(a) a user communicating with a service provider that offers a plurality of hard copy products and selecting a particular hard copy product to incorporate a digital document provided by the user;
(b) the user providing an identification of the designee's location where the selected hard copy product is to be delivered;
(c) the service provider automatically selecting, from a plurality of printing locations, a particular printing location based on the identification of the designee's location;
(d) using a communications network to transfer the digital document from the user to the particular printing location; and
(e) printing the selected hard copy product at the particular printing location and delivering the hard copy product to the designee.

28. The method of claim 27 wherein the user makes payment via the network for the hard copy product.

29. The method of claim 27 wherein the identification of the designee's location is the designee's zip code.

30. The method of claim 29 wherein the hard copy product is delivered to the designee by the U.S. postal service.
